(19) United States
(12) Patent Application Publication
(10) Pub. No.: US 2006/0140098 A1
(43) Pub. Date: Jun. 29, 2006

(54) Recording audio broadcast program

(76) Inventors: Mark A. Champion, Kenmore, WA (US); Donald B. Moore, Renton, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/025,517

(22) Filed: Dec. 29, 2004

(51) Int. Cl. G11B 5/09

(52) U.S. Cl. 369/59.21; 369/124.04

(57) ABSTRACT

An embodiment of the present invention includes a technique to record a radio broadcast program. A recording circuit records an encoded digital stream corresponding to a program signal onto a storage unit starting at a start recording time. The program signal is received by a receiver and corresponds to an audio program.

### BACKGROUND

1. Field of the Invention

Embodiments of the invention relates to the field of audio broadcasting, and more specifically, to recording audio broadcast programs.

2. Description of Related Art

Home entertaining systems including television and radio have become popular due to advances in communication and processor technologies. Vehicles are now equipped with many advanced features that provide convenience, comfort, and safety for the users. For example, modern automobiles are commonly installed with sophisticated audio entertaining systems or modules such as high fidelity radio tuners, compact disc (CD) players, audio cassette players, etc. Audio equipment and receivers or tuners have also been developed with capabilities to record and mix music with a number of different formats.

However, there are several instances where the user may not be able to listen to the broadcast program although he or she wants to. For example, a driver of an automobile commuting to work may have to stop listening to a favorite radio program when he or she arrives at work. A home-maker may have to leave her house to attend a parent teacher meeting while her radio is playing her favorite songs.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a time-shift record and playback module according to one embodiment of the invention.

FIG. 3 is a diagram illustrating a time-shift record and playback module using a processing unit according to one embodiment of the invention.

FIG. 4 is a diagram illustrating a process to record and playback audio broadcast programs according to one embodiment of the invention.

FIG. 5 is a flowchart illustrating a process to record audio broadcast programs according to one embodiment of the invention.

FIG. 6 is a flowchart illustrating a process to playback an audio broadcast program according to one embodiment of the invention.

### DESCRIPTION

An embodiment of the present invention includes a technique to record a radio broadcast program. A recording circuit records an encoded digital stream corresponding to a program signal onto a storage unit starting at a start recording time. The program signal is received by a receiver and corresponds to an audio program.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

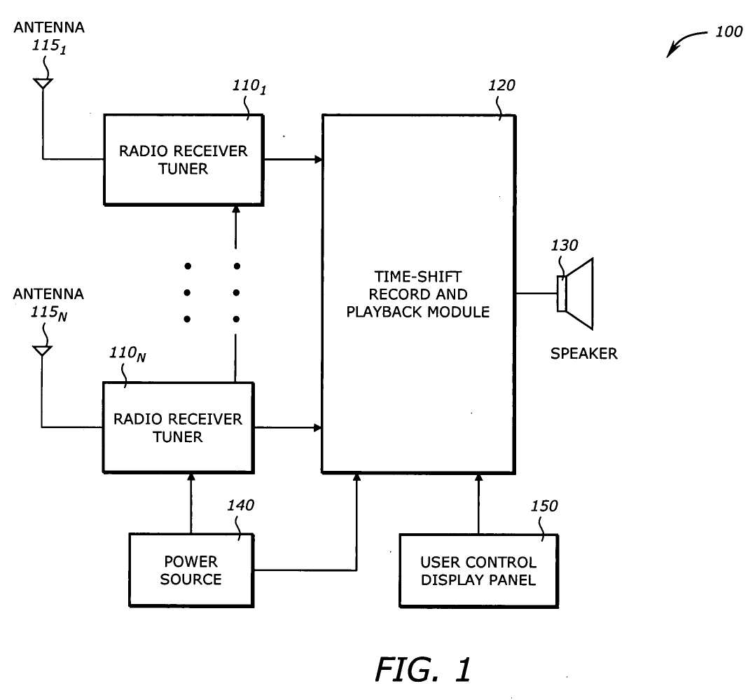

FIG. 1 is a diagram illustrating a system 100 in which one embodiment of the invention can be practiced. The system 100 includes N radio receivers/tuners 110₁ to 110_{N} where N is a positive integer, a time-shift record and playback module 120, a speaker 130, a power source 140, and a user control/display panel 150. Note that the system 100 may contain more or less than the above elements.

The system 100 is typically installed in a vehicle such as an automobile, a van, a recreational vehicle, a boat, etc. However, the system 100 may also be used in any applications where time-shift recording and/or playback of radio broadcast programs is desired. For example, the system 100 may be used at home, at an office, at a warehouse, or even at outdoor locations such as in a picnic, a camp, a football game, a recreational park, etc. In a typical application, a user wishes to record a time-shift or future program because he or she may not be available for listening at that time or because he or she simply wants to record for future listening. “Time-shifting” here refers to the ability to capture the audio content at one time and play it back at another time. The system 100 allows various configurations according to the user's settings. It may allow the user to record one or more programs or listen to one program while recording one or more programs.

Each of the radio receivers/tuners 110₁ to 110_{N} receives radio broadcast programs or the audio portion of a television broadcast program via one or more antennae 115₁ through 115_{P} where P≦N. One antenna may be shared by more than one tuners. Each of the radio receivers/tuners 110₁ to 110_{N} may be a self-contained unit having audio outputs or part of an integrated unit. The radio receivers/tuners 110₁ to 110_{N} provide program signals carrying the associated radio broadcast programs. The radio broadcast program received by each of the radio receivers/tuners 110₁ to 110_{N} may be any broadcast program such as a talk show, a commentary, a sports program, a music program, an educational program, a religious program, etc. Note that although the system 100 is shown with multiple radio receivers/tuners, in many applications, there is only one radio receiver/tuner. The reference of 110₁ to 110_{N} includes multiple radio receiver/tuner or a single radio receiver/tuner. The radio programs may also be programs from satellites or Internet. In addition, the programs may also be any non-radio audio information source.

The time-shift record and playback module 120 records a selected radio broadcast program in a storage medium and plays back the recorded program. Note that the module 120 does not have to have both functionalities. It may provide a recording functionality only, or a playback functionality only. The speaker 130 is an audio speaker that is used during playback or when voice/audio output is desired.

The power source 140 provides power for the radio receivers/tuners 110₁ to 110_{N} and the time-shift record and playback module 120. The power source 140 may be a car battery, a separate battery source, or an alternating current (AC) power line at home or at the office. In a typical scenario, the user is not using the radio receivers/tuners 110₁ to 110_{N} and is not available for listening to the programs. The radio receivers/tuners 110₁ to 110_{N} may be turned off to save power. When the recording time starts, the power source 140 energizes the radio receivers/tuners 110₁ to 110_{N} and the time-shift record and playback module 120. For example, the user may be driving a car and listening to a sports program. When the user arrives at the destination while the program is still going on, the user sets the start recording time and the end recording time (e.g., 5:30 pm) or the desired recording duration (e.g., one hour). The start recording time may be a default time as the time the power is turned off. The user then turns off the engine. The power source 140, in this case, may be the car battery. It continues to provide power to a controller which energizes the radio receiver/tuner and the module 120 for the duration of the recording.

The user control and display panel 150 provides a user interface to allow the user to set the desired settings or control the module 120. It also provides display indicators to show status or feedback information or any other information. The user control and display panel 150 may be interfaced to the module 120 via wired or wireless connection. The wireless connection may be any one of a radio frequency (RF), optical (e.g., infrared) or sonic connection. It may have its own power source. The control function may be implemented by switches, buttons, etc. to allow the user to set the start and end recording times, to select radio receiver/tuner whose received broadcast program is to be recorded. This control function may be part of other control functions in the system such as the clock or timer at the dash board of an automobile. The display function may include light-emitting diode (LED) display, flat panel display, liquid crystal display (LCD), or any suitable display. The display indicators may include indicators to show whether the module 120 is in a record mode, a playback mode, a sleeping mode, or a standby mode. It may also include alphanumeric display to show the time, the date, the radio receiver/tuner identifier, the number of programs to be recorded, etc.

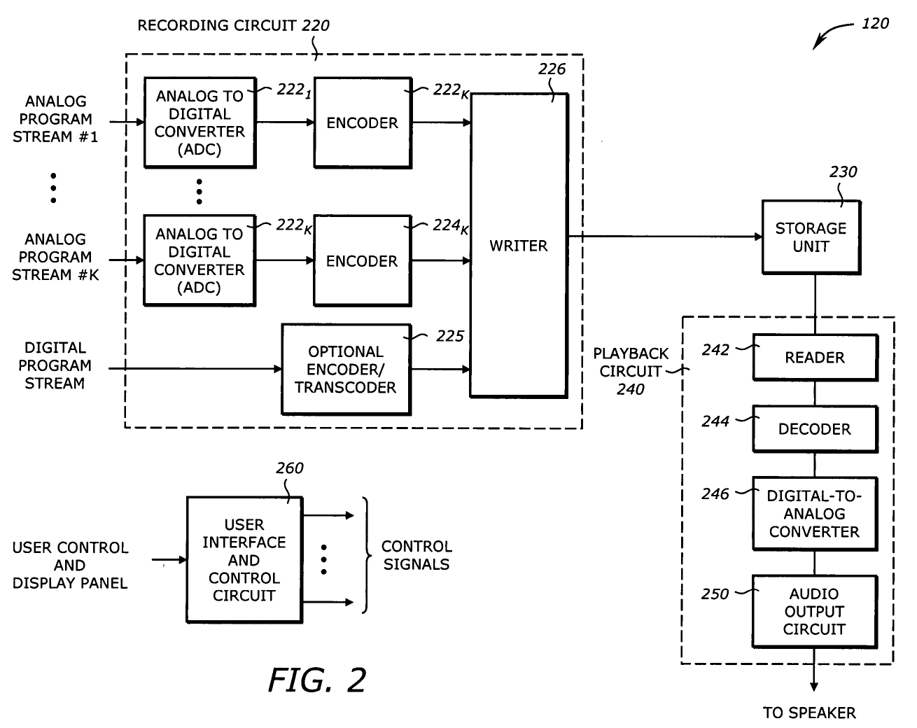

FIG. 2 is a diagram illustrating the time-shift record and playback module 120 according to one embodiment of the invention. The module 120 includes a recording circuit 220, a storage unit 230, a playback circuit 240, an audio output circuit 250, and a user interface and control circuit 260. As discussed earlier, the module 120 may include only the recording functionality which includes the input circuit 210, the recording circuit 220, and the storage unit 230; or only the playback functionality which includes the storage unit 230, the playback circuit 240 and the audio output circuit 250.

The module 120 receives at least one of K analog program signals/streams and a digital program stream. In other words, the program signal may be an analog signal or a digital stream. The recording circuit 220 records an encoded digital stream corresponding to the program signal(s)/stream(s) onto the storage unit 230 starting at a start recording time. It includes K analog-to-digital converters (ADCS) 222₁ to 222_{K}, K encoders 224₁ to 224_{K}, an optional encoder and/or transcoder 225 and a writer 226. Each of the ADCS 222₁ to 222_{K} converts a corresponding analog program signal into a digital stream. The ADCs 222₁ to 222_{K} may have different conversion rates according to the type of programs or the desired audio quality. The conversion rate or sampling rate may be determined by the encoding technique or the types of program. Typically the sampling rate is from 8 kHz to 48 kHz. For music program, the sampling rate is typically 41.2 kHz or selectable by the user according to the desired audio quality. The resolution of the digital sample depends on the quality of the audio program. For example, for music programs, the quality is high and the resolution may be 16-bit or 18-bit. For talk show programs, the quality is medium and the resolution may be 8-bit, 12-bit, or 16-bit. Each of the encoders 224₁ to 224_{K} encodes the digital stream into the encoded digital stream. The optional encoder or transcoder 225 also encodes or transcodes the digital program stream into the encoded digital stream. If the digital program stream has been properly encoded (e.g., compressed in appropriate format), then the encoder/transcoder 225 may not be needed. The encoders 224₁ to 224_{K} and 225 encode the digital stream using a compression format of one of a medium quality and one of a high quality. The compression format or technique may be any one of a pulse code modulation (PCM), adaptive differential PCM (ADPCM), μ-law compression, Motion Picture Experts Group (MPEG) audio compression, and MP3 compression. As is known by one skilled in the art, any other compression format may be used. The high quality compression format is typically for high fidelity programs such as music program. The medium quality compression format is typically for other audio programs such as sports program, talk show, etc. The writer 226 writes the encoded digital stream onto the storage unit 230. The encoded digital stream may correspond to multiple audio programs. The writer 226 is also capable of writing multiple digital streams onto the storage unit 230. The writer 226 may write to the storage unit 230 according to some writing scheme to facilitate the playback or retrieval of the information.

The storage unit 230 stores the encoded digital stream corresponding to a portion of an audio broadcast program. It may be any suitable storage medium. It may be any one of a flash memory, a non-volatile memory, an electronic disk, a fast optical disk, a removable storage medium (e.g., memory stick). In one embodiment, the storage unit 230 is a removable storage medium that can be removed and plugged into a playback device to playback the audio program.

The playback circuit 240 plays back the encoded digital stream stored in the storage unit 230. The playback circuit 240 may be a module separated from the recording circuit 220. The playback circuit 240 includes a reader 242, a decoder 244, and a digital-to-analog converter (DAC) unit 246. For stereo audio signals, the DAC unit 246 may include two DAC's. The reader 242 reads the encoded digital stream from the storage unit 230. The reading may be performed according to the pattern or scheme that is used by the writer 226. The decoder 244 decodes the encoded digital stream to a decoded digital stream. The decoding may be performed according to the encoding format or scheme used by the encoder 224. The decoding may be the complementary version of the encoding scheme. It may be any one of a pulse code de-modulation, adaptive differential PCM (ADPCM), μ-law decompression, Motion Picture Experts Group (MPEG) audio decompression, and MP3 decompression. The DAC 246 converts the decoded digital stream to an output signal. The conversion rate and/or the sample resolution depend on the type of program. For example, for high quality audio programs such as music, the resolution may be 16-bit or 18-bit. The conversion rate may be comparable to the sampling rate of the ADC 222 and may range from 8 kHz to 48 kHz.

The audio output circuit 250 generates an audio output from the output signal. It may include audio analog circuits such as a filter, an amplifier circuit, a programmable gain amplifier circuit, or an instrumentation amplifier circuit. The audio output is then fed to the speaker to generate audio signal. For stereo audio, the various amplifier circuits may include two amplifiers each.

The user interface and control circuit 260 includes interfacing devices to perform input/output functions such as receiving user input (e.g., selection of radio receivers/tuners, selection of sampling rate, selection of compression format, setting of start recording and end times). It may also generate control signals to various elements in the system such as multiplexing select control, conversion control signals to the ADCs 222₁ to 222_{K} and/or the DAC 250, control signals to select compression format for the encoders 224₁ to 224_{K} and/or 225 or decompression format for the decoder 244.

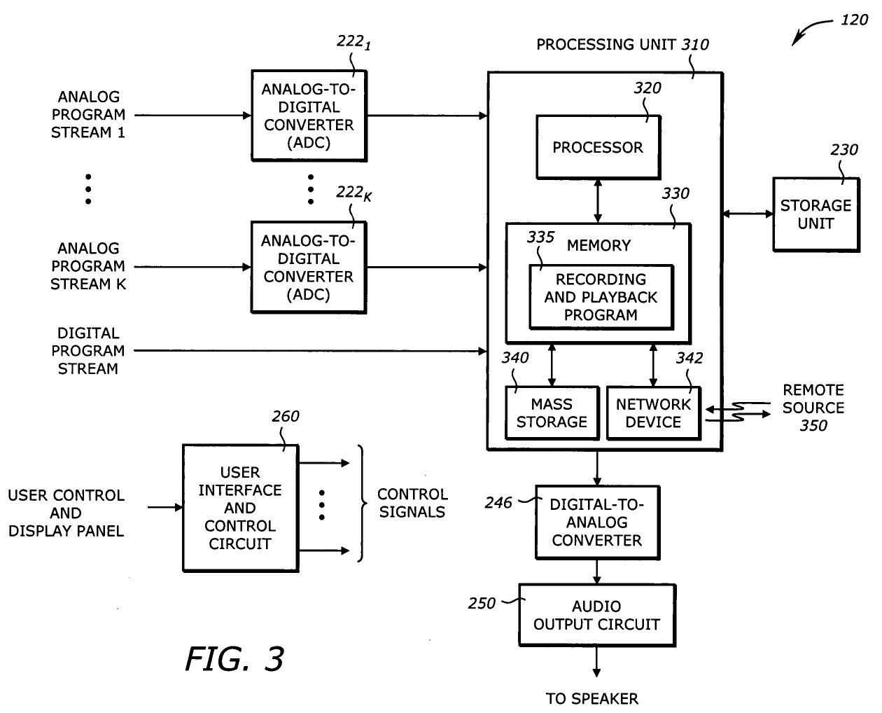

FIG. 3 is a diagram illustrating the time-shift record and playback module 120 using a processing unit according to one embodiment of the invention. The module 120 shown in FIG. 3 is essentially equivalent to that of shown in FIG. 2. The module 120 of FIG. 3 differs than that of FIG. 2 in that it uses a software approach to implement the encoding, writing, reading, and decoding functions performed by the encoder 224, the writer 226, the reader 242, and the decoder 244, respectively. It includes the ADCs 222₁ to 222_{K}, a processing unit 310, the storage unit 230, the DAC 246, the audio output circuit 250, and the user interface and control circuit 260.

The ADCs 222₁ to 222_{K}, the storage unit 230, the DAC 246, the audio output circuit 250, and the user interface and control circuit 260, are essentially the same as those shown in FIG. 2. Therefore, the same reference numerals are used and their descriptions are not repeated here.

The processing unit 310 performs the encoding, writing, reading, and decoding functions as described earlier. The processing unit 310 includes a processor 320, a memory 330, a mass storage device 340, and a network device 342. The processing unit 310 may also include other elements such as input/output (I/O) devices, memory controller hub (MCH), I/O controller hub (ICH), peripheral devices, etc. The processing unit 310 may also generate control signals to various elements in the system such as control signals to the ADCs 222₁ to 222_{K}, the DAC 246, and the audio output circuit 250, etc.

The processor 320 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The memory 330 stores code and data. The memory 330 is typically implemented with dynamic random access memory (DRAM) or static random access memory (SRAM). It may also be implemented by non-volatile memory such as flash memory to store program code. The memory 330 may include program code or code segments implementing one embodiment of the invention, such as a recording and/or playback program 335. Any one of the elements of the recording and/or playback program 335 may be implemented by hardware, software, firmware, microcode, or any combination thereof. The memory 330 may also include other programs or data which are not shown, such as an operating system. The recording and/or playback program 335 includes the functionalities of at least one of the encoder 224ᵢ (i=0, . . . K), the encoder and/or transcoder 225, the writer 226, the reader 242, and the decoder 244. Not all of these functionalities are performed by the program 335. Any combination of hardware and software can be used. For example, the program 335 may only perform the encoding and/or decoding functions, while the writing and/or reading functions are performed by corresponding hardware circuits as shown in FIG. 2.

The mass storage device 340 stores archive information such as code, programs, files, data, applications, and operating systems. The mass storage device 340 may include electronic disk (e.g. flash), a compact disk (CD) ROM, a digital video/versatile disc (DVD), floppy drive, and hard drive, and any other magnetic or optic storage devices. The mass storage device 340 provides a mechanism to read machine-accessible media. The machine-accessible media may contain computer readable program code to perform tasks as described above.

The network device 342 provides wireless connectivity to a remote source 350. The remote source 350 may be any suitable source that is capable of wireless transmission. The remote source 350 may be a home computer, a desktop, a laptop, a notebook, a personal digital assistant (PDA), a cellular phone, a music unit, an audio player (e.g., MP3 music player), etc. The wireless connectivity may be any suitable wireless connectivity such as radio frequency (RF), electromagnetics, optics (e.g., infrared), or ultrasound. Any wireless standards may be employed such as Institute of Electronics and Electrical Engineers (IEEE) 801.11b, Bluetooth, Wireless Fidelity (Wi-Fi), hot-spots, etc. The wireless connectivity may be used to receive or transmit information such as audio content, commands, status, or data from or to the remote source 350. For example, a user may upload an MP3 file or an audio book from his home office to the record and playback module 120 in the car inside the garage before he goes to work. In another scenario, the user may download the recorded talk show audio program to his home computer when he arrives home from work to listen to from his home computer.

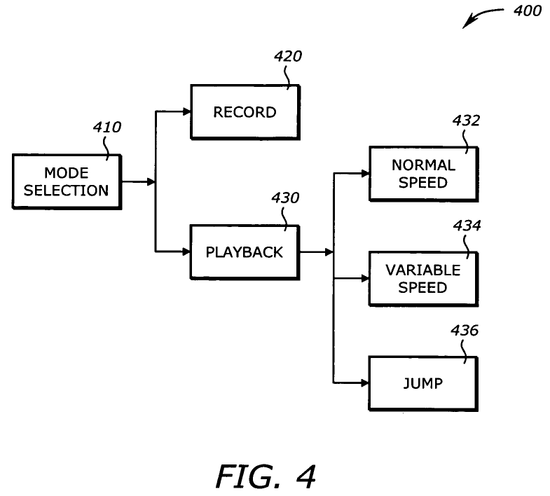

FIG. 4 is a diagram illustrating a process 400 to record and playback audio broadcast programs according to one embodiment of the invention. The process 400 includes a mode selection module 410, a record module 420, and a playback module 430.

The mode selection module 410 includes various options selected by the user. The options correspond to different operational modes including recording mode, playback mode, record while playback mode, playback at normal speed, jump to next audio segment, etc. The module 410 may call one or both of the record and playback modules 420 and 430. Various control functions are provided to allow the user to select any desired listening, record, or playback modes. The user may pause a live audio program or a playback because he may be temporarily doing something else (e.g., answering a phone call). While a live audio program is paused, it may be recorded so that the user may continue listening where he left off, thereby listening to a delayed version of the audio program. The user may want to fast forward, rewind, or jump to a different audio segment. The user may upload a recorded program to a remote computer. The user may record one audio program while listening to a previously recorded audio program at the same time or in any overlapping segments (e.g., recording for 5 minutes then start listening to previously recorded program while continuing recording the current program, etc.). In other words, the mode selection module 410 allows the user to perform any control functions using the record and playback modules 420 and 430.

The record module 420 is a process to record the audio program that is being broadcast. The playback module 430 is a process to play back the recorded audio program or programs. The playback module 430 may include a normal speed module 432, a variable speed module 434, and a jump module 436. Any of the modules 432, 434, and 436 may have a forward direction and a reverse, or rewind, direction.

The normal speed module 432 allows the playback to proceed with the same speed as originally recorded. This is typically the default speed selection.

The variable speed module 434 allows the playback to proceed at a speed different than the recording speed. The playback speed may be faster or slower than the recording speed. The faster speed is typically used to shorten the playback such as when the user wants to catch up with real-time audio after having paused for some period (e.g., when the user has to pause the real-time audio program to take a phone call). The slower speed may be used when the user wants to slow down the pace of the real-time audio to hear more clearly (e.g., slow down speech of a fast talker, beats of music). The degree of speed increase or decrease may be any specified number, such as 25%, 50% faster or slower. Additional processing may be applied to the variable speed playback mode. One such processing is a pitch correction operation. This operation allows the speech pitch to be raised or lowered independently of the playback speed. This results in a more natural audio signal and avoids the pitch distortion that would otherwise occur.

The jump module 436 allows the user to jump to a marked program segment, either forward or backward. The recorded program may be marked with any type or marking method. In one method, the marking is at a fixed interval (e.g., 5 minutes). In this method, each time the user presses a jump button, the program jumps to the next interval. In another method, the marking is at some variable interval. For example, the audio program may be marked when there is a significant pause in the audio such as a transition between program and commercial. In another example, the program may be marked when there is a significant difference between the average energies of some audio segments such as when a song is finished. Various detection methods may be employed to determine whether an audio segment is a music segment, a talk show segment, a sports event segment, or a commercial segment, etc. for marking purposes.

Since the audio program is digitally stored at real-time speed, the implementation of the various playback modes is straightforward. For the normal speed, the reading of the audio samples from the storage unit 230 proceeds with the same rate as the recording rate, e.g., consecutively stored samples. For the fast speed, the reading retrieves samples at a faster rate or skips samples according to some predefined values corresponding to the selected increase. For the slow speed, the reading retrieves samples at a slower rate or replicates samples according to some predefined values corresponding to the selected decrease. Additional processing or filtering schemes may be employed. For example, instead of simple replication for the slow speed, linear or quadratic interpolation may be used between adjacent samples. Similarly, for the fast speed, smoothing operations may be applied to samples after sample skipping.

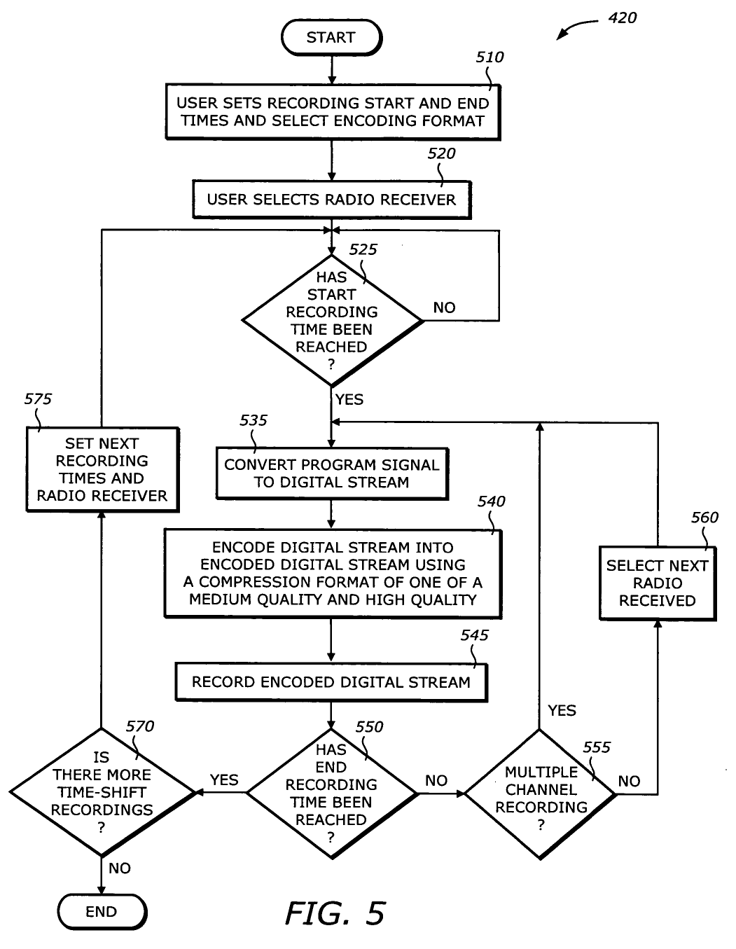

FIG. 5 is a flowchart illustrating the process 420 to record audio broadcast programs according to one embodiment of the invention. Note that the process 420 may be repeated as many times as necessary depending on the number of programs to be recorded.

Upon START, the user sets the recording start and end times and selects the encoding format (Block 510). Next, the user selects the radio station (Block 520). If there are multiple radio receivers/tuners, this operation corresponds to the first radio receiver/tuner. Then, the process 420 determines if the start recording time has been reached (Block 525). If not, the process 420 returns back to Block 525. Otherwise, the process 420 proceeds to the recording operation.

Next, the process 420 converts the program signal to a digital stream (Block 535). Note that the term “stream” may refer to a stream of data, a series of digital samples, or a single digital sample. This can be performed by sending a start conversion signal to the ADC 222. Then, the process 420 encodes the digital stream into an encoded digital stream (Block 540). The encoding uses a compression format of one of a medium quality and high quality as discussed above.

Next, the process 420 records the encoded digital stream onto the storage unit (Block 545). Then, the process 420 determines if the end recording time has been reached (Block 550). If not, the process 420 determines if multiple channel recording is desired (Block 555). If only a single channel recording is desired, the process 420 returns to Block 535 to continue the conversion and encoding operations. Otherwise, the process 420 selects the next radio station (Block 560) and return to Block 530.

Alternatively, the process 420 may correspond to a simple radio receiver/tuner. If there are multiple radio receivers/tuners, then the device can use any appropriate algorithm to determine which radio receiver/tuner will be used to record each radio program. In that case, the block 555 and 560 may include the radio receiver/tuner selection algorithm.

If the end recording time has been reached, the process 420 determines if there are any more time-shift recording for the selected radio receiver/tuner (Block 570). If not, the process 420 is terminated. Otherwise, the process 420 goes back to Block 525 to wait for the next start recording time.

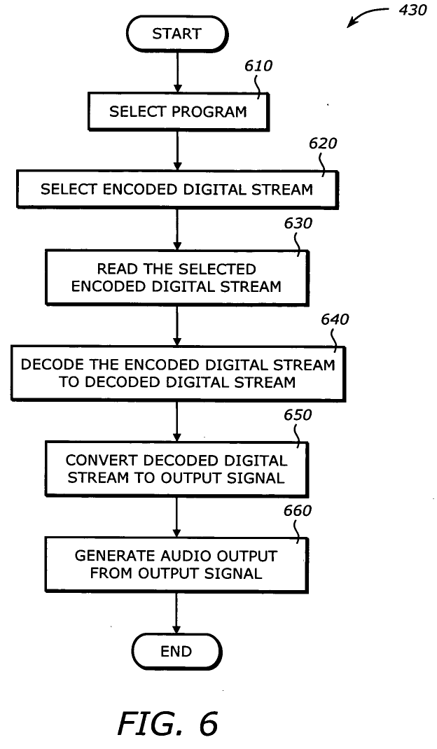

FIG. 6 is a flowchart illustrating the process 430 to playback an audio broadcast program according to one embodiment of the invention.

Upon START, the process 430 selects the encoded digital stream from the storage unit (Block 620). This selection depends on how the streams are recorded onto the storage unit. Next, the process 430 reads the selected encoded digital stream (Block 630). Block 630 may include any of the playback modules shown in FIG. 4. Then, the process 430 decodes the encoded digital stream to a decoded digital stream (Block 640). The decoding operation corresponds to the encoding operation.

Next, the process 430 converts the decoded digital stream to an output signal (Block 650). This can be performed by sending the digital stream to the DAC 246 (FIG. 2). Then, the process 430 generates an audio output from the output signal (Block 660) and is then terminated.

Elements of one embodiment of the invention may be implemented by hardware, firmware, software or any combination thereof. The term hardware generally refers to an element having a physical structure such as electronic, electromagnetic, optical, electro-optical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc. that is implemented or embodied in a hardware structure (e.g., flash memory, ROM, EPROM). Examples of firmware may include microcode, writable control store, and microprogrammed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable/programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The machine accessible medium may also include program code embedded therein. The program code may include machine readable code to perform the operations described above. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a recording circuit to record an encoded digital stream corresponding to a program signal onto a storage unit starting at a start recording time, the program signal being received by a receiver and corresponding to an audio program.

2. The apparatus of claim 1 wherein the recording circuit comprises
a writer to write the encoded digital stream onto the storage unit.

3. The apparatus of claim 2 wherein the recording circuit further comprises:
an encoder to encode a digital stream representing the program signal into the encoded digital stream.

4. The apparatus of claim 3 wherein the recording circuit further comprises:
an analog-to-digital converter (ADC) to convert the program signal into a digital stream.

5. The apparatus of claim 3 wherein the encoder encodes the digital stream using a compression format of one of a medium quality and one of a high quality.

6. The apparatus of claim 1 wherein the recording circuit stops recording the encoded digital stream at an end recording time.

7. The apparatus of claim 6 further comprising:
a user interface circuit to provide user interface control to select at least one of the first radio receiver, the start recording time, and the end recording time.

8. The apparatus of claim 1 wherein the storage unit is a removable storage medium.

9. An apparatus comprising:
a storage unit to store an encoded digital stream corresponding to an audio program signal; and
a playback circuit coupled to the storage unit to play back the encoded digital stream.

10. The apparatus of claim 9 wherein the playback circuit comprises:
a reader to read the encoded digital stream from the storage unit;
a decoder to decode the encoded digital stream to a decoded digital stream; and
a digital-to-analog converter (DAC) coupled to the decoder to convert the decoded digital stream to an output signal.

11. The apparatus of claim 10 wherein the playback circuit further comprises:
an audio output circuit coupled to the DAC to generate an audio output from the output signal.

12. The apparatus of claim 10 wherein the reader reads the encoded digital stream at one of a normal speed, a variable speed, and a jump.

13. The apparatus of claim 10 wherein the reader reads the encoded digital stream at one of a forward direction and a reverse direction.

14. The apparatus of claim 9 further comprising:
a network device to receive and transmit information from and to a remote source using a wireless connectivity.

15. The apparatus of claim 14 wherein the information includes at least one of an audio content, a command, a status, and data.

16. The apparatus of claim 13 wherein the remote source is one of a computer, a personal digital assistant (PDA), a cellular unit, and an audio player.

17. A method comprising:
recording an encoded digital stream corresponding to a program signal onto a storage unit starting at a start recording time, the program signal being received by a receiver and corresponding to an audio program.

18. The method of claim 17 wherein recording comprises
writing the encoded digital stream onto the storage unit.

19. The method of claim 18 wherein recording further comprises:
encoding a digital stream representing the program signal into the encoded digital stream.

20. The method of claim 18 wherein recording further comprises
converting the program signal into the digital stream.

21. The method of claim 19 wherein encoding the digital stream comprises encoding using a compression format of one of a medium quality and one of a high quality.

22. The method of claim 17 wherein recording comprises stopping recording the encoded digital stream at an end recording time.

23. The method of claim 22 further comprising:
providing user interface control to select at least one of the first radio station, the first radio receiver, the start recording time, and the end recording time.

24. The method of claim 17 wherein the storage unit is a removable storage medium.

25. A method comprising:
storing an encoded digital stream corresponding to an audio program signal in a storage unit; and
playing back the encoded digital stream.

26. The method of claim 25 wherein playing back comprises:
reading the encoded digital stream from the storage unit;
decoding the encoded digital stream to a decoded digital stream; and
converting the decoded digital stream to an output signal.

27. The method of claim 26 wherein playing back further comprises:
generating an audio output from the output signal.

28. The method of claim 26 wherein reading comprises:
reading the encoded digital stream at one of a normal speed, a variable speed, and a jump.

29. The method of claim 26 wherein reading comprises:
reading the encoded digital stream at one of a forward direction and a reverse direction.

30. The method of claim 25 further comprises:
receiving and transmitting information from and to a remote source using a wireless connectivity.

31. The method of claim 30 wherein the information includes at least one of an audio content, a command, a status, and data.

32. The method of claim 30 wherein the remote source is one of a computer, a personal digital assistant (PDA), cellular unit, and an audio player.

33. An article of manufacture comprising:
a machine-accessible medium including data that, when accessed by a machine, causes the machine to perform operations comprising:
receiving a program signal from a first radio receiver that receives a first radio broadcast program; and
recording an encoded digital stream corresponding to the program signal onto a storage unit starting at a start recording time.

34. The article of manufacture of claim 33 wherein the data causing the machine to perform recording comprises data that, when accessed by the machine, causes the machine to perform operations comprising:
writing the encoded digital stream onto the storage unit.

35. The article of manufacture of claim 33 wherein the data causing the machine to perform recording further comprises data that, when accessed by the machine, causes the machine to perform operations comprising:
encoding a digital stream representing the program signal into the encoded digital stream.

36. The article of manufacture of claim 33 wherein the data causing the machine to perform recording further comprises data that, when accessed by the machine, causes the machine to perform operations comprising:
converting the program signal into the digital stream.

37. The article of manufacture of claim 35 wherein the data causing the machine to perform encoding the digital stream comprises data that, when accessed by the machine, causes the machine to perform operations comprising:
encoding using a compression format of one of a medium quality and one of a high quality.

38. The article of manufacture of claim 33 wherein the data causing the machine to perform recording comprises data that, when accessed by the machine, causes the machine to perform operations comprising:
stopping recording the encoded digital stream at an end recording time.

39. The article of manufacture of claim 38 wherein the data further comprises data that, when accessed by the machine, causes the machine to perform operations comprising:
providing user interface control to select at least one of the first radio station, the first radio receiver, the start recording time, and the end recording time.

40. The article of manufacture of claim 31 wherein the storage unit is a removable storage medium.

41. An article of manufacture comprising:
a machine-accessible medium including data that, when accessed by the machine, causes the machine to perform operations comprising:
storing an encoded digital stream corresponding to an audio program signal in a storage unit; and
playing back the encoded digital stream.

42. The article of manufacture of claim 41 wherein the data causing the machine to perform playing back comprises data that, when accessed by the machine, causes the machine to perform operations comprising:
reading the encoded digital stream from the storage unit;
decoding the encoded digital stream to a decoded digital stream; and
converting the decoded digital stream to an output signal.

43. The article of manufacture of claim 42 wherein the data causing the machine to perform playing back further comprises data that, when accessed by the machine, causes the machine to perform operations comprising:
generating an audio output from the output signal.

44. The article of manufacture of claim 42 wherein the data causing the machine to perform reading further comprises data that, when accessed by the machine, causes the machine to perform operations comprising:
reading the encoded digital stream at one of a normal speed, a variable speed, and a jump.

45. The article of manufacture of claim 42 wherein the data causing the machine to perform reading further comprises data that, when accessed by the machine, causes the machine to perform operations comprising:
reading the encoded digital stream at one of a forward direction and a reverse direction.

46. The article of manufacture of claim 41 further comprises data that, when accessed by the machine, causes the machine to perform operations comprising:
receiving and transmitting information from and to a remote source using a wireless connectivity.

47. The article of manufacture of claim 46 wherein the information includes at least one of an audio content, a command, a status, and data.

48. The article of manufacture of claim 46 wherein the remote source is one of a computer, a personal digital assistant (PDA), a cellular unit, and an audio player.

49. A system comprising:
at least one or more radio receivers/tuners to receive a program signal; and
a time-shift recording and playback module coupled to the at least one or more radio receivers/tuners, the module comprising:
a recording circuit to record an encoded digital stream corresponding to the program signal onto a storage unit starting at a start recording time.

50. The system of claim 49 wherein the recording circuit comprises
a writer to write the encoded digital stream onto the storage unit.

51. The system of claim 49 wherein the recording circuit further comprises:
an encoder to encode a digital stream representing the program signal into the encoded digital stream.

52. The system of claim 49 wherein the recording circuit further comprises:
an analog-to-digital converter (ADC) to convert the program signal into the digital stream.

53. The system of claim 51 wherein the encoder encodes the digital stream using a compression format of one of a medium quality and one of a high quality.

54. The system of claim 49 wherein the recording circuit stops recording the encoded digital stream at an end recording time.

55. The system of claim 54 wherein the module further comprises:
a user interface circuit to provide user interface control to select at least one of the first radio station, the first radio receiver, the start recording time, and the end recording time.

56. The system of claim 49 wherein the storage unit is a removable storage medium.

57. The system of claim 49 wherein the time-shift recording and playback module further comprises:
a playback circuit coupled to the storage unit to play back the encoded digital stream.

58. The system of claim 57 wherein the playback circuit comprises:
a reader to read the encoded digital stream from the storage unit;
a decoder to decode the encoded digital stream to a decoded digital stream; and
a digital-to-analog converter (DAC) coupled to the decoder to convert the decoded digital stream to an output signal.

59. The system of claim 58 wherein the playback circuit further comprises:
an audio output circuit coupled to the DAC to generate an audio output from the output signal.

60. The system of claim 58 wherein the reader reads the encoded digital stream at one of a normal speed, a variable speed, and a jump.

61. The system of claim 58 wherein the reader reads the encoded digital stream at one of a forward direction and a reverse direction.

62. The system of claim 57 wherein the time-shift recording and playback module further comprises:
a network device to receive and transmit information from and to a remote source in a wireless connectivity.

63. The system of claim 62 wherein the information includes an audio content, a command, a status, and data.

64. The system of claim 62 wherein the remote source is one of a computer, a personal digital assistant (PDA), a cellular unit, and an audio player.
